(19) United States
(12) Patent Application Publication
(10) Pub. No.: US 2014/0058681 A1
(43) Pub. Date: Feb. 27, 2014

(54) METHODS FOR JOINT CALLING OF BIOLOGICAL SEQUENCES

(71) Applicant: Real Time Genomics, Inc., San Bruno, CA (US)

(72) Inventors: John Gerald CLEARY, Hamilton (NZ); Sean A. Irvine, Hamilton (NZ); Kurt Oliver Gaastra, Hamilton (NZ); Leonard Eric Trigg, Ngahinapouri (NZ)

(73) Assignee: Real Time Genomics, Inc., San Bruno, CA (US)

(21) Appl. No.: 13/971,630

(22) Filed: Aug. 20, 2013

Related U.S. Application Data
(60) Provisional application No. 61/691,271, filed on Aug. 21, 2012.
(60) Provisional application No. 61/729,462, filed on Nov. 23, 2012.
(60) Provisional application No. 61/803,671, filed on Mar. 20, 2013.

(51) Int. Cl. G06F 17/18

(52) U.S. Cl. CPC G06F 17/18
USPC 702/19

(57) ABSTRACT

Methods and systems for simultaneously evaluating biological sequences across multiple population members, and methods and systems for simultaneously calling normal and cancerous biological sequences from a mixed sample containing normal and cancerous material are disclosed. This may be achieved by evaluating the probability of one or more hypothesis being correct for a plurality of population members based on biological sequence information for the population. For related family members, Mendelian inheritance may be integrated into the method. For populations, information from members under evaluation may be used to refine priors to more accurately call population members. Copy number variation, de novo mutations, and phenotypic traits and their genetic explanations may also be accommodated in the methods. Specific systems for implementing the methods are also disclosed.

### CROSS-REFERENCE TO RELATED APPLICATIONS

This application claims priority to U.S. Provisional Application No. 61/691,271, filed Aug. 21, 2012; U.S. Provisional Application No. 61/729,462, filed Nov. 23, 2012; and U.S. Provisional Application No. 61/803,671, filed Mar. 20, 2013; all of which are incorporated by reference herein.

The inventions described herein relate to methods for simultaneously evaluating biological sequences, including cancer-related sequences, and systems therefor. The methods and systems additionally may incorporate Mendelian inheritance among related family members. The inventions also relate to probability-based calling methods suitable for use in calling sequences for reads obtained from samples containing both normal and cancerous material. There are also disclosed methods incorporating copy number variation into probability-based calling methods. There are also disclosed methods incorporating phenotypic traits and genetic explanations for the traits, as well as integrated systems incorporating each individual modeling feature into single systems.

There have been great advances in genomic sequencing in recent times. Sequencing machines can generate reads ever more rapidly with increasingly accurate results. However, there remain errors in the reads produced and during the process of read alignment the reads must be assembled as best as possible to generate the most accurate genomic sequence for the sample possible. The process of “calling” a value of the sequence from the reads requires consideration of a range of relevant factors and potential sources of errors.

Additionally, there has been much research to identify predisposing genomic sequence variants and somatic mutations. The basis for this research is the accurate calling of cancerous sequences obtained from tumors and related samples. However, many samples have included a mixture of normal biological sequences and cancerous biological sequences and the quality of calling has been reduced for such mixed samples as the reads for the normal samples act as contamination of the cancerous samples.

A wide range of algorithms for calling sequence values have been employed. Some use filtering techniques but this potentially loses information that may assist in making a call or values that upon more thorough investigation may be the best calls. Mendelian inheritance rules have been used to investigate family relationships but have not been fully exploited. Prior approaches have not looked to other family members as part of a larger dynamic model. Such approaches have had limited success in correctly identifying the likelihood of de novo mutations.

Other techniques for calling biological sequences include prior U.S. Pat. No. 7,640,256 and U.S. application Ser. Nos. 13/129,329 and 61/695,408, and PCT/NZ2011/000080, PCT/NZ2011/000081 and PCT/NZ2011/000197 which are hereby incorporated by reference.

Some prior calling techniques may assume that the sample is uncontaminated (i.e. either all normal or all cancerous material) and have not been able to make accurate calls for mixed samples of cancerous and normal biological material or where there is copy number variation (which is common with cancer).

It would be desirable to improve the quality of calling by utilizing population information in an integrated model. It would also be desirable to improve the quality of calling for mixed samples or where there is copy number variation.

It is an object of the disclosed inventions to provide improved methods of calling biological sequences that overcome at least some of these problems.

In some embodiments, the invention provides a method of calling a target biological sequence of a biological sequence source based on a set of sequence reads, the method performed by one or more processors executing program instructions stored on one or more memories, the instructions causing the one or more processors to perform the method comprising:

obtaining biological sequence read information from a target biological sequence source and a second biological sequence source, wherein the target source and the second source are genetically related;

modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source; and
a biological sequence of the second biological sequence source; and
one or more random variables chosen from:
   contamination of a set of sequence reads that correspond to a biological sequence source;
   the copy number of a genomic sequence of a biological sequence source;
   the presence of de novo mutation in a genomic sequence of a biological sequence source; and
   a phenotypic trait;
and

providing one or more likely values for one or more random variables in the set of random variables.

In some embodiments, the invention provides a method of calling a target biological sequence of a biological sequence source based on a set of sequence reads, the method performed by one or more processors executing program instructions stored on one or more memories, the instructions causing the one or more processors to perform the method comprising:

obtaining biological sequence read information from a target biological sequence source and a second biological sequence source, wherein the target source and the second source are genetically related, and wherein the target source and the second source are not two members of a family of individual organisms;

modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source;
a biological sequence of the second biological sequence source; and
a variable representing contamination of a set of sequence reads that correspond to a biological sequence source; and

providing one or more likely values for one or more random variables in the set of random variables.

In some embodiments, the invention provides a system for calling a target biological sequence of a biological sequence source based on a set of sequence reads, the system comprising:
one or more processors configured to execute one or more modules; and
a memory storing the one or more modules, the modules comprising:
code for obtaining biological sequence read information from a target biological sequence source and a second biological sequence source, wherein the target source and the second source are genetically related;
code for modeling the probabilities of occurrence of the possible values of a set of random variables using a Bayesian network, the set of random variables comprising:
   a set of sequence reads that correspond to the target biological sequence source;
   a biological sequence of the target biological sequence source;
   a set of sequence reads that correspond to the second biological sequence source; and
   a biological sequence of the second biological sequence source;
   and
   one or more random variables chosen from:
      contamination of a set of sequence reads that correspond to a biological sequence source;
      the copy number of a biological sequence of a biological sequence source;
      the presence of de novo mutation in a biological sequence of a biological sequence source; and
      a phenotypic trait;
   and
   code for providing one or more likely values for the biological sequence of the target source and/or one or more likely values for the biological sequence of the second biological sequence source.

Additional objects and advantages of the invention will be set forth in part in the description that follows.

It is acknowledged that the terms “comprise,” “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

It is to be understood that both the foregoing general description and the following detailed description are exemplary and explanatory only and are not restrictive of the invention, as claimed.

### BRIEF DESCRIPTION OF THE DRAWINGS

Reference will now be made to the accompanying drawings showing example embodiments of this disclosure. In the drawings:

FIG. 1 is an exemplary Bayesian Network that represents the copy numbers (C) and genotypes (G) for one or more samples given the sets of reads (S) for those samples in a singleton calling context, consistent with embodiments of the present disclosure.

FIG. 2 is an exemplary Bayesian Network in which a set of reads appears as individual reads (Rᵢ), consistent with embodiments of the present disclosure.

FIG. 3 shows an abbreviation that will sometimes be used when illustrating certain embodiments, such as those involving large Bayesian networks such as pedigrees. It can be used to indicate this common combined network including S (or R), G, C, N, B, and M.

FIG. 4 is an exemplary Bayesian Network that represents the case where one sample is known to be descended from a single other sample including random variables for the copy number of the original and descendant samples, consistent with embodiments of the present disclosure.

FIG. 5 is an exemplary Bayesian Network that represents the case where the possibility of mutation is integrated into the network of FIG. 4, consistent with embodiments of the present disclosure.

FIG. 6 is an exemplary Bayesian Network that represents multiple branching descendants, consistent with embodiments of the present disclosure.

FIG. 7 is an exemplary Bayesian Network that represents a sequence of multiple descendants, consistent with embodiments of the present disclosure.

FIG. 8 is an exemplary Bayesian Network that represents a pedigree containing multiple descendants, showing both branching and a series of generations, consistent with embodiments of the present disclosure.

FIG. 9 is an exemplary Bayesian Network that incorporates a random variable (A₁) that models contamination, consistent with embodiments of the present disclosure.

FIG. 10 is an exemplary Bayesian Network representing a family with two parents and one child, consistent with embodiments of the present disclosure.

FIG. 11 is an exemplary Bayesian Network representing a family with two parents and multiple children, consistent with embodiments of the present disclosure.

FIG. 12 is an exemplary Bayesian Network representing an extended pedigree with multiple generations, consistent with embodiments of the present disclosure.

FIG. 13 is an exemplary Bayesian Network representing a family with two parents and one child, expanded to explicitly allow for copy number and genotype mutations, consistent with embodiments of the present disclosure.

FIG. 14 is an exemplary Bayesian Network representing a family with two parents and one child, expanded to explicitly allow for phenotypic traits (D) and the explanation (U), consistent with embodiments of the present disclosure.

FIG. 15 is an exemplary Bayesian Network representing a family pedigree that illustrates how one or more of the disclosed networks can be combined in a unified model, consistent with embodiments of the present disclosure.

### DETAILED DESCRIPTION

When developing a representation of a biological sequence from a biological sample sequencing machines produce many reads of short portions of the subject sequence (typically DNA, RNA or proteins). These reads (biological sequence information) must be aligned and then “calls” must be made as to values of the sequence at each location (e.g., individual bases for DNA). There may typically be only a few reads (and sometimes none) at a particular location or very many reads in others.

Errors can arise in process of sequencing genomes. In some cases all reads are consistent or “simple calls” may be made using conventional calling techniques. There are typically “regions of interest” that may span a single or several values where more sophisticated analysis can be required to make a reliable call. A region may be identified as a region of interest, as the confidence in calling the region may be too low using simple calling techniques or there may be characteristics of the region indicating deeper analysis is desirable. These characteristics may be numbers of insertions and/or deletions, the value and proximity of calls (e.g. a number of low confidence calls close to each other) etc.

The problems are compounded when, for example:
(1) The sample includes both genomic information relating to normal and cancerous biological material; and/or
(2) The number of copies of parts of the genomic sequence varies (i.e. in cancerous cells more copies of parts of the DNA may be present than others—a phenomenon known as copy number variance).

A Bayesian approach may be applied to resolve calls in such regions of interest. This is a principled way of combining multiple factors and allows evolving knowledge to be dynamically integrated.

Such regions of interest can be evaluated without reference to family members or a related population. Such regions of interest can also be evaluated without taking into account contamination (mixed normal and cancerous biological samples) or copy number variation (certain portions of the genomic sequence may have more copies due to a cancer). But the exclusion of family member, related population, and contamination information removes a large volume of information that can assist in making reliable calls in difficult regions. Accordingly, in certain embodiments, the reads for multiple samples may be evaluated simultaneously so that all information is utilized to inform the calling of biological sequences for each sample and provide more accurate calling. Additionally, in certain embodiments, the model is adjusted to account for contamination and/or copy number variation to improve the accuracy of calling biological sequences.

In certain embodiments, a Bayesian model can be applied to calling a biological sequence.

As used herein, “CPD” refers to a conditional probability distribution.

As used herein, a “read” may be a DNA sequence, an RNA sequence, a cDNA sequence, a protein sequence, or textual representations of such sequences. A read may be measured using an instrument or assay, such as, for example, a DNA sequencer, shotgun sequencing, or a next-generation sequencing method. Examples of next-generation sequencing methods include massively parallel signature sequencing, polony sequencing, 454 pyrosequencing, Solexa sequencing, SOLiD sequencing, and nanopore DNA sequencing. A read may also be obtained from literature values or public sequence databases such as EMBL, GenBank, and dbSNP.

As used herein, a “sample” may be any specimen from an organism that contains material that can be sequenced, e.g., extracted somatic tissue, gametes such as sperm, blood, or urine. A sample may comprise isolated DNA, RNA, chromosomes, or protein sequences. A sample may include bacteria or mitochondria. A sample may include cancerous tissue, noncancerous tissue, precancerous tissue, and/or tumor tissue.

As used herein, two sources of biological sequence are “genetically related” if one is descended from the other (e.g., grandparent to grandchild, or original and progeny cells, including but not limited to progeny cells bearing mutations relative to the original cells, e.g., cancerous cells which originated from originally noncancerous tissue) or if both can trace descent to a common source (e.g., cells descended from a common progenitor, siblings, or cousins).

As used herein, a “family” is a group of at least two individual organisms (family members) in which each individual organism in the family is a parent or child via sexual reproduction of at least one other individual organism in the family.

As used herein, sequence reads “correspond” to a source if the reads were generated by sequencing a physical sample taken from the source, or if they were generated computationally from a known, draft, or estimated sequence of the source (e.g., by simulating a sequencing methodology on the sequence to produce reads).

As used herein, the degree of relationship (DOR) between two sources is the minimum number of steps through lines of descent by which the sources are separated in a pedigree. Thus, for example, a parent and child have a DOR of one; siblings have a DOR of two; an aunt and niece have a DOR of three; and cousins have a DOR of four.

As used herein, a tissue or cell is pre-cancerous if it shows one or more pathological changes that may be preliminary to malignancy. Thus, a tissue or cell may be determined to be pre-cancerous based on, e.g., abnormal morphology, genetic mutations and/or gene expression patterns associated with carcinogenesis and not present in surrounding tissue, etc.

As used herein, “germ line” is used in a generic and relative sense to refer to cells or tissue of an original genotype from which another group of cells or tissue is descended, and is not limited to gametes and cells that develop into gametes. For example, healthy epithelial tissue would be considered germ line relative to a precancerous or cancerous growth within the epithelial tissue.

The notation used in this disclosure closely follows that used in “Probabilistic Graphical Models: Principles and Techniques”, Koller, D., Friedman, N., MIT Press, 2009.

In this disclosure, particular classes of random variables are referred to using the following notation:

Set-of-reads (S)—set of reads mapped to a particular locus (just the subset of nucleotides from the read that map to that locus).

Read (R)—the part of a single read mapped to a particular locus.

Copy Number (C)—the number of copies of each reference sequence.

Selection copies (B)—a vector of copy numbers detailing how children are generated from parents (e.g., it describes any mutations in copy number).

Haplotype (H)—a single sequence, usually a variant within a reference DNA sequence.

Genotype (G)—an ordered vector of the haplotypes at a particular locus (the number of them is determined by C and it is assumed that different orders of the haplotypes cannot be distinguished).

de novo (N)—binary indicator that a variant is a de novo mutation (that is, it is not present in its parents).

Local mutation (M)—vector of binary indicators that a mutation has occurred for a haplotype (used when analyzing mutation in diploid and more complex genotypes).

Contamination (A)—a real value between 0 and 1 that indicates the amount of contamination of one sample by another.

Disease (D)—binary value that says whether an individual has a trait or not (often the trait is a genetic disease).

Cause (U)—set of genotypes that is a putative cause of a disease.

The initial letters of the random variables are often used in diagrams and formulas (S, R, C, B, H, G, N, M, A, D, U). Lower case letters are used for particular values (s, r, c, b, h, g, n, m, a, d, u).

X, Y, and Z are used to denote generic random variables, and x, y, and z are used to denote values of generic random variables.

Bold upper case letters (e.g., X) are used to indicate sets of random variables, and x for the corresponding sets of values. The set of all random variables is given by χ. Upper case versions of the particular type of random variables will indicate all instances of that type (e.g. G will be used for the set of all genotype random variables).

The standard definition of Bayes' formula is:

$$P ( X \vert Y ) = \frac{P ( Y \vert X ) P ( X )}{P ( Y )}$$

This can be derived from the identity

P(X|Y)P(Y)=P(Y|X)P(X)=P(X,Y)

Additionally,

P(Y)=ΣₓP(Y|x)P(x)=ΣₓP(Y,x)

In most cases below the disclosure provides an expression for the term

P(χ)=P(X|Y)P(Y)=P(Y|X)P(X)

where

χ=X [symbol] Y

Such an expression combined with the equations above can be used to compute various answers of the form P(X|Y).

In certain embodiments, given sets of reads (S) for a set of samples, the goal is to find the genotypes (G) for one or more of those samples. However, this is not the only information that we may want to extract. For example, it may be of interest to know the copy numbers (C), whether a mutation has occurred (N), and/or details of mutations (B,M) for use in other tools or to aid human understanding of what is happening.

### 1. Singleton Calling.

In certain embodiments, one can infer the genotype from the supplied reads and/or can infer the copy number from the reads (for example, it may be possible to get an accurate estimate of the copy number even if the genotypes are not exactly known). To evaluate these inferences, the CPDs P(G|s) and P(C|s) can be computed.

The CPDs can be computed from the expression

P(χ)=P(S|G)P(G)

using Bayes formula where:

P(G) is the prior for the genotypes which is estimated from population studies of biological samples and from other theoretical information about mutation rates;

P(S|G) is the CPD for the reads in the sample given the genotypes this will be described further below.

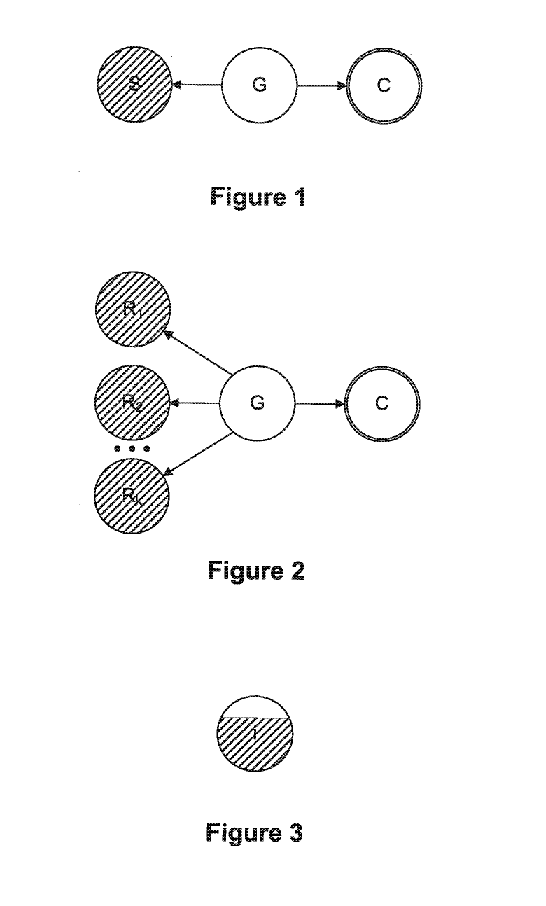

The diagram in FIG. 1 shows a Bayesian Network for this situation. The shaded circle surrounding S shows the random variable that can be supplied as observations. The double circle around the copy number C indicates that it can be computed deterministically from G (e.g., it can be computed as the length of the vector associated with G).

The copy number at a particular location can be influenced both by the biology of the situation and by mutations; for example, by sections of a genome that have been deleted or duplicated.

Possible interesting biological cases include: C=2 for eukaryotic autosomes; C=1 for haploid sequences in bacteria, sperm, mitochondria and sex chromosomes. For example, in humans both the X and Y chromosomes for males are haploid. In cancer C values can vary greatly from 0 for deleted regions to 5 or more for repeatedly duplicated regions. Thus in many cases C can have a fixed value known a priori (often 1 or 2). In other cases such as with cancerous tissue, it may sometimes be inferred from the sample.

P(S|G) can be computed using the following relationship:

P(s|G)=Π_{rεs}P(r|G)

That is, the probability of the set of reads can be taken to be the product of the probability of each of the individual reads given the genotype. This assumes that the reads are independent of each other.

An expanded Bayesian Network representation for this situation is as follows. The disclosure will typically not use this expanded representation, leaving it as understood that when we use S it represents a set of reads as shown in FIG. 2.

We can provide P(R|G) to complete this analysis as follows.

Let g= [symbol] h₁, h₂, . . . , h_{c} [symbol] where c is the copy number. Then:

$$P ( R \vert g ) = \frac{{\sum }_{i} P ( R \vert {h}_{i} )}{c}$$

For example, consider the situation where the haplotypes can range over the individual values “A,C,G,T”, and then

$$P ( r \vert 〈 A , T 〉 ) = \frac{P ( r \vert A ) + P ( r \vert T )}{2}$$

That is, in this embodiment, the probability of an heterozygous diploid genotype is the average of the probability of its two constituent haplotypes.

The probability of an individual read, assuming a single haplotype, P(R|H), can often be computed using a table such as the one below:

TABLE 1

| | P(r\|h) |
|---|---|
| r = h | 1 − ε |
| r ≠ h | $\frac{ε}{( c - 1 )}$ |

where ε is the probability that the sequencing machine will make an error (and c is the copy number). More complex tables can be provided where, for example, the probability of an error depends on the neighboring nucleotides in the read or the reference.

FIG. 3 shows an abbreviation that will sometimes be used when illustrating certain embodiments, such as those involving large Bayesian networks such as pedigrees. It can be used to indicate this common combined network including S (or R), G and C and later also N, B, M. In certain embodiments, only an integer label rather than a random variable is included to indicate which sample it is taken from.

1.1. Incorrect Mapping

In some embodiments, the equations above are modified to allow for the possibility that a read has been mapped incorrectly to a locus. For example:

P′(R|G)=(1−η)P(R|G)+ηP(R)

where η is the probability that the read is incorrectly mapped and P′(R|G) is the modified version of P(R|G).

### 2. Single Parent Descent

In some embodiments, situations where there is a single parent leading to one or more descendants are analyzed. These situations are generalized to a linear sequence of such parent child relationships and then to pedigrees (branching trees). These cases can occur when dealing with, e.g., prokaryotes, cancer lineages and derived cell lines.

2.1. Simple Descent

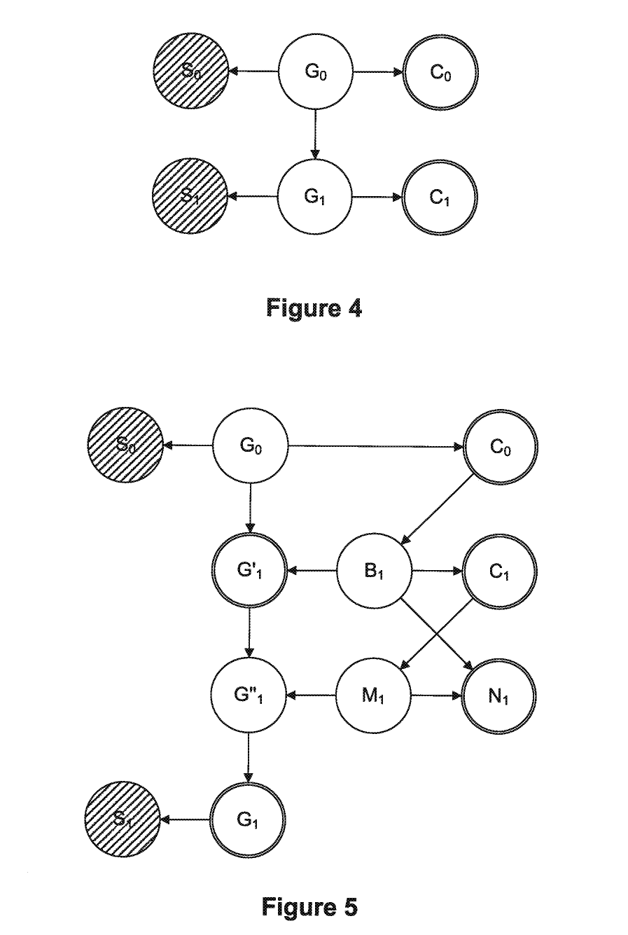

In some embodiments, one sample is known to be descended from a single other sample, and there is a possibility of mutation of both the copy number and of the genotype. See, e.g., FIG. 4. This covers situations such as the descent of a cancer cell from the germ line, a parent and daughter prokaryote or a single step in a derived cell line. The cancer case is dealt with in more detail later where issues such as contamination of the tumor sample by the germ line are covered.

As in the singleton case, it may be of primary interest to infer the genotypes of the parent and child. However other details such as the copy number and details of any mutations may be of interest independently of or in addition to the foregoing. With respect to parent and child genotypes, the inferences from the Bayesian network above include P(G₀|s), P(G₁|s), P(C₀|s), and P(C₁|s).

These can be computed from

P(χ)=P(s₁|G₁)P(G₁|G₀)P(s₀|G₀)P(G₀)

In what follows factors ψᵢ will be used to isolate the contributions local to a node i and its immediate parent or parents.

ψ₀(G₀)≡P(s₀|G₀)P(G₀)

ψ₁(G₀,G₁)≡P(s₁|G₁)P(G₁|G₀)

then P(χ) can be written as

P(χ)=ψ₀(G₀)ψ₁(G₀,G₁)

As an example, P(G₀|s) can be inferred as follows. First compute

$$\begin{matrix}P ( {G}_{0} , s ) = {\sum }_{{G}_{1}} P ( χ ) \\ = {\sum }_{{G}_{1}} P ( {s}_{1} \vert {G}_{1} ) P ( {G}_{1} \vert {G}_{0} ) P ( {s}_{0} \vert {G}_{0} ) P ( {G}_{0} )\end{matrix}$$

Then using Bayes formula we normalize the values in P(G₀, s) to give P(G₀|s):

$$P ( {G}_{0} \vert s ) = \frac{P ( {G}_{0} , s )}{{\sum }_{{G}_{0}} P ( {G}_{0} , s )}$$

P(C₀|s) can be inferred similarly. First compute

$$\begin{matrix}P ( {c}_{0} , s ) = {\sum }_{{G}_{0}} {\sum }_{{G}_{1}} P ( χ ) whenever {c}_{0} = \vert {G}_{0} \vert \\ = {\sum }_{{G}_{0}} {\sum }_{{G}_{1}} P ( {s}_{1} \vert {G}_{1} ) P ( {G}_{1} \vert {G}_{0} ) P ( {s}_{0} \vert {G}_{0} ) \\ whenever {c}_{0} = \vert {G}_{0} \vert\end{matrix}$$

Then using Bayes formula we normalize the values in P(C₀,s) to give P(C₀|s):

$$P ( {C}_{0} \vert s ) = \frac{P ( {C}_{0} , s )}{{\sum }_{{G}_{0}} P ( {C}_{0} , s )}$$

P(G₁|s) and P(C₁|s) are computed similarly.

P(G₁|G₀) is the CPD for the child's genotype given the parent. In the absence of mutation this is deterministic (G₁ is equal to G₀). In the presence of mutation P(G₁|G₀) could be treated as a black box, however, this does little to explain its biological relevance and also makes it impossible to infer more detailed information such as whether a mutation has actually occurred or not. The Bayesian network shown in FIG. 5 shows the additional random variables and their relationships introduced to allow inference of more detailed information.

This diagram computes G₁ in two steps. First a vector B₁ is generated that describes any mutations in copy number and how to extract this from G₀. The result of the generation is recorded as a temporary genotype G′₁. This genotype may not be of interest, such that extraction of its probability distribution for the user is not necessarily performed.

Second a vector of mutation flags M₁ is generated and used to modify G′₁ to the temporary genotype G″₁. Again, this genotype may not be of interest, such that extraction of its probability distribution for the user is not necessarily performed. The items in the vector G″₁ are sorted, if necessary according to some consistent ordering to give the target genotype G₁. N₁ is true if any of the flags in M₁ are true or if any of the counts in B₁ differ from 1. C₁ can be computed deterministically from B₁ or the lengths of any of G′₁, G″₁, G₁.

If these new random variables are not to be explicitly inferred then P(χ) remains unchanged and P(G₁|G₀) can be computed from the formula

P(G₁|G₀)=Σ_{B}_{₁}Σ_{M}_{₁}P(G″₁|M₁,G′₁)P(M₁|C₁)P(B₁|C₀)

whenever

C₀=|G₀|,C₁=|G′₁|,G′₁=rep(G₀,B₁),N₁=or(B₁,M₁),G₁=sorted(G″₁)

If the new random variables are to be inferred then let

χ′=χ∪{G′₁,G″₁,B₁,M₁,C₀,C₁,N₁}

and

P(χ′)=P(s₁|G₁)P(G″₁|M₁,G′₁)P(M₁|C₁)P(B₁|C₀)P(s₀|G₀)P(G₀)

The new random variables G′₁, G″₁, B₁, M₁, C₀, C₁, N₁ are now described in detail.

B₁ is a vector of (non-negative) integers whose length is specified by c₀. Each integer specifies the number of copies to take of the corresponding allele in G₀. Thus the sum of the integers in B₁ specifies the length of G₁, that is:

if B₁= [symbol] b₁, b₂, . . . , b_{c}_{₀} [symbol] then

c₁=Σⱼ₌₁^{c}^{₀}bⱼ

If G₀= [symbol] h₁, h₂, . . . , h_{c}_{₀} [symbol] then the function rep(G₀, B₁) can take each haplotype hⱼ and replicates it bⱼ times giving a new vector of length c₁ (because G₀ is already sorted this result is also sorted). For example if G₀= [symbol] A,C,G,T [symbol] and B₁= [symbol] 1,0,2,0 [symbol] then s(G₀, B₁)= [symbol] A,G,G [symbol] .

In some embodiments, B₁ is by default a vector of all 1s (that is there is no change in copy number). In eukaryotic cell lines where c₀=2 then B₁= [symbol] 2,0 [symbol] or B₁= [symbol] 0,2 [symbol] might correspond to a gene conversion event where one haplotype has been replaced by the other giving two copies. P(B₁|C₀) will be determined by knowledge of the rates of copy number changes and gene conversions and similar phenomena in biological populations. In some embodiments, e.g., cancer, and/or where one or more DNA repair systems are not fully functional, such events can be relatively much more likely than in germ line or otherwise normal cells.

M₁ is a vector of true/false values of length c₁. Each true value indicates that the corresponding haplotype in G′₁ should be mutated. In some embodiments, the CPD P(M|C) is specified by assuming that there is an underlying rate of haploid mutations μ which sets the value for each item in M independently, that is, if M= [symbol] m₁, m₂, . . . , m_{c} [symbol] then:

P(M|c)=Πⱼ₌₁^{c}P(mⱼ)

where P(mⱼ=true)=μ and P(mⱼ=false)=1−μ. Alternatively, it can be assumed that at most one of the mⱼ can be true, in which case each of these unit vectors is given a probability of μ and the all false vector is given a probability of 1−cμ. This approach relies on μ being much less than 1, such that the cases where there is more than one mutation can be safely ignored.

P(G″₁|M₁,G′₁) gives the CPD by mutating each allele in G′₁ independently. Thus if G′₁= [symbol] h′₁, h′₂, . . . , h′_{c}_{₁} [symbol] , G″₁= [symbol] h″₁, h″₂, . . . , h″_{c}_{₁} [symbol] , and M₁= [symbol] m₁, m₂, . . . , m_{c}_{₁}

[symbol]

P(g″₁|m₁,g′₁)=Πⱼ₌₁^{c}^{₁}P(h″ⱼ|mⱼ,h′ⱼ)

where P(h″ⱼ|mⱼ, h′ⱼ) is given by the following table. l is the number of different possible haplotypes (4 for ordinary SNPs but larger in more complex situations).

TABLE 2

| | m | P(h″\|m, h′) |
|---|---|---|
| h′ = h″ | true | 0 |
| h′ ≠ h″ | true | $\frac{1}{l - 1}$ |
| h′ = h″ | false | 1 |
| h′ ≠ h″ | false | 0 |

2.2. Examples of Single Descent Situations

The general technique discussed above can be illustrated with a number of biological examples.

In eukaryotic cell lines the most common case is that of an autosome where C₀=C₁=2 (ignoring any copy number variations).

The case where C₀=C₁=1 represents, amongst many possibilities:
one prokaryote descended from another,
a mitochondrion descended from a mother's mitochondrion.
the Y chromosome where sample 0 is a male mammal and sample 1 is his son.
the Y chromosome where sample 0 is a male mammal and sample 1 a sperm.
the W chromosome where sample 0 is a female bird and sample 1 is a female offspring.

The case where C₀=2 and C₁=1 represents, amongst many possibilities:
X chromosome where sample 0 is a female mammal and sample 1 is a male child.
Autosome where sample 0 is a male and sample 1 is a sperm.
Autosome where sample 0 is a female and sample 1 is a hydatiform mole.
Z chromosomes where sample 0 is a male and sample 1 is a female offspring among birds and other non-mammalian species.

In each of these cases the two most likely values for B₁ are [symbol] 1,0 [symbol] and [symbol] 0,1 [symbol] . That is, ignoring any mutations,

P( [symbol] 1,0 [symbol] |2)=P( [symbol] 0,1 [symbol] |2)=½

### 3. Multiple Descent

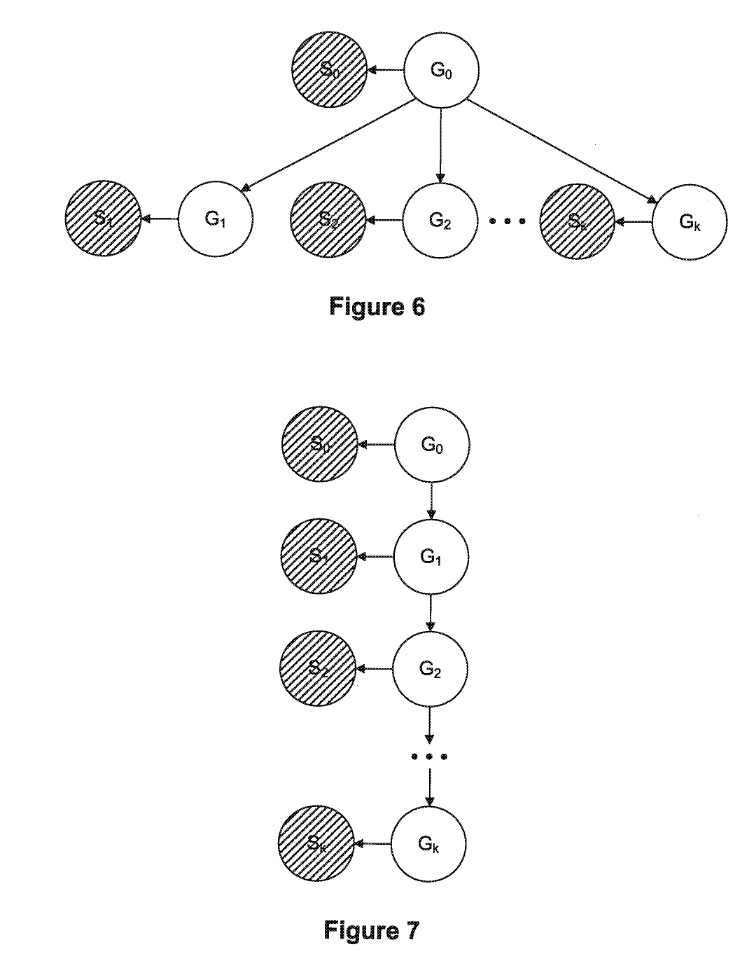

The analysis of the last section is now extended to include multiple descendants, as illustrated by the Bayesian network shown in FIG. 6.

This diagram can be applied to the cases mentioned above of cell lines, bacteria and cancer. It also describes the situation for identical twins (or triplets or higher multiplets) when S₀ will be empty (it corresponds to the zygote before splitting into identical twins and any subsequent de novo mutations).

As above P(Gᵢ|s) can be computed from:

P(χ)=P(s₀|G₀)P(G₀)Πᵢ₌₁^{k}P(sᵢ|Gᵢ)P(Gᵢ|G₀)

Refactoring in terms of ψ gives

ψ₀(G₀)≡P(s₀|G₀)P(G₀)

ψᵢ(G₀,Gᵢ)≡P(sᵢ|Gᵢ)P(Gᵢ|G₀)i≧1

then

P(χ)=ψ₀(G₀)Π_{i≧1}ψᵢ(G₀,Gᵢ)

The details at each of the random variables B, C, M, N have been omitted. They are local to each node and can be added back in systematically by expanding P(Gᵢ|G₀). Then P(χ) can be used to infer their values.

3.1. Series

The analysis of the preceding section is now extended to include a sequence of multiple descendants, giving the Bayesian network shown in FIG. 7.

P(Gᵢ|s) can be inferred from:

P(χ)=P(s₀|G₀)P(G₀)Πᵢ₌₁^{k}P(sᵢ|Gᵢ)P(Gᵢ|Gᵢ₋₁)

Refactoring in terms of ψ gives

ψ₀(G₀≡P(s₀|G₀)P(G₀)

ψᵢ(G₀,Gᵢ)≡P(sᵢ|Gᵢ)P(Gᵢ|Gᵢ₋₁)i≧1

then

P(χ)=ψ₀(G₀)Π_{i≧1}ψᵢ(Gᵢ₋₁,Gᵢ)

This expression completely defines the problem. However, a plurality or all of the different inferences may be computed efficiently by using Forward-Backward variable elimination (also known as Belief Propagation) (Koller et al., Chapter 9).

The expression P(χ) which encapsulates the full Bayesian Network has in each case been defined as the product of the various ψᵢ factors. Although the details of how each of these is defined and which random variables they take as arguments may vary from sample to sample they can still be combined into one product for the whole pedigree. So in schematic form

P(χ)=Πᵢψᵢ

3.2. Pedigree with Multiple Descent

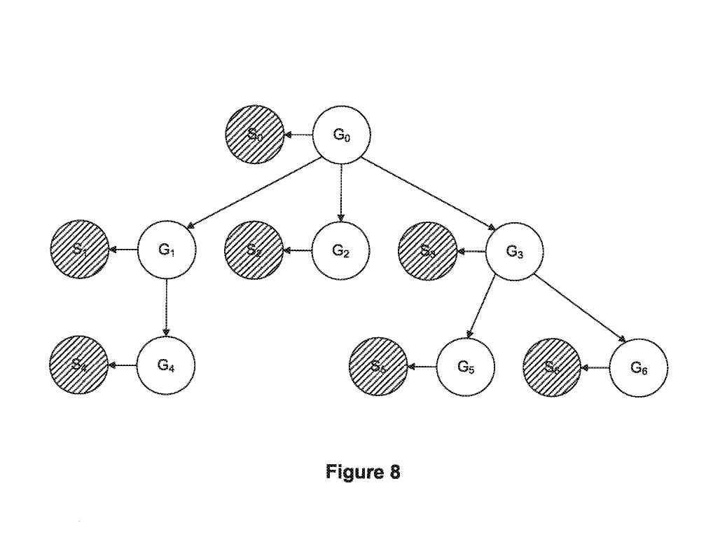

Combining the circumstances of branching and series allows forming a Bayesian Network in the form of a tree as exemplified in FIG. 8.

A general way of expressing the parents and children of a sample i allows formulation of the various expressions in this most general case.

Let i^{↑} be the (unique) parent of node i (not defined for the root node 0).

i is a leaf if [symbol] j:j^{↑}=i.

Let i^{↓} be the set of children of i.

The siblings of i are defined by

sib(i)≡(i^{↑})^{↓}−{i}.

This gives

P(χ)=P(s₀|G₀)P(G₀)Πᵢ₌₁^{k}P(sᵢ|Gᵢ)P(Gᵢ|Gᵢ_{^{↑}})

Refactoring in terms of ψ:

ψ₀(G₀)≡P(s₀|G₀)P(G₀)

ψᵢ(Gᵢ_{^{↑}},Gᵢ)≡P(sᵢ|Gᵢ)P(Gᵢ|Gᵢ_{^{↑}})i≧1

P(χ)=ψ₀(G₀)Π_{i≧1}ψᵢ(Gᵢ_{⁵²},Gᵢ)

### 4. Contamination

Consider now a situation where material from sample 0 is present in sample 1. This can be relevant for cancer where sample 0 is the normal cells and sample 1 is the tumor cells, which may contain an admixture of sample 0.

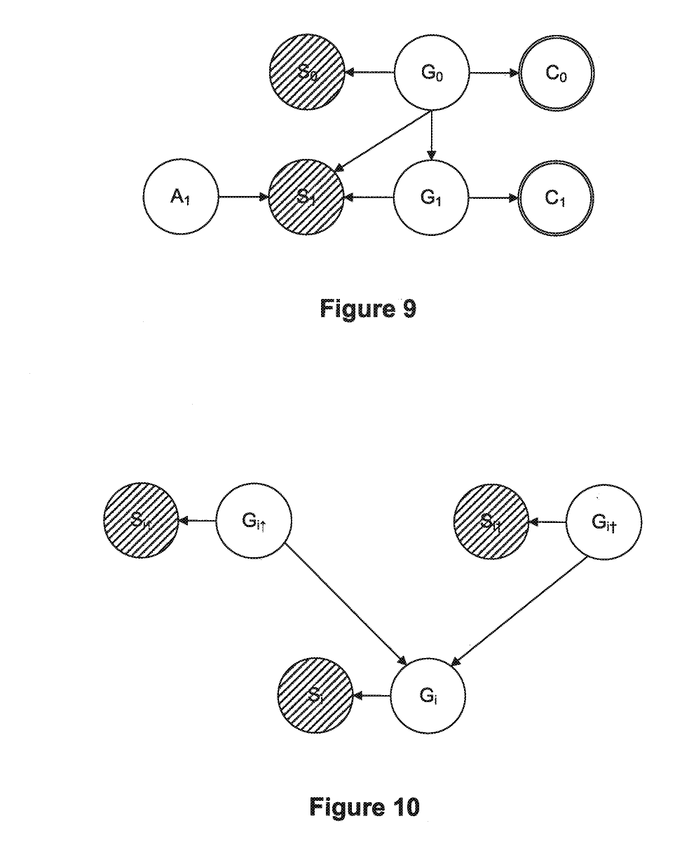

To model this a random variable A₁—the probability that material from sample 0 is present in sample 1—is introduced. See, e.g., FIG. 9. In the context of cancer A₁ is often referred to as cellularity. A specified value may be known for A₁, or it may be useful to provide a prior for A₁ and estimate it. Being a probability A₁ ranges continuously from 0 to 1. When it is eliminated in the various expressions below an integration is used rather than a sum.

As well as the usual inferences P(G₀|s), P(G₁|s), P(C₀|s), and P(C₁|s), P(A₁|s) may also be inferred, such as by using

P(χ)=P(S₁|G₁,G₀,A₁)P(G₁|G₀)P(A₁)P(s₀|G₀)P(G₀)

The new factor P(s₁|G₁,G₀,A₁) is defined by

P(s₁|G₁,G₀,A₁)=Πᵣ_{₁}_{εs}_{₁}P(r₁|G₁,G₀,A₁)

where the probability of an allele is the weighted sum of the probabilities in samples 0 and 1:

P(r₁|G₁,G₀,a₁)=a₁P(r₁|G₀)+(1−a₁)P(r₁|G₁)

Refactoring in terms of ψ gives

ψ₀(G₀)≡P(s₀|G₀)P(G₀)

ψ₁(G₀,G₁,A₁)≡P(S₁|G₁,G₀,A₁)P(G₁|G₀)P(A₁)

then P(χ) can be written as

P(χ)=ψ₀(G₀)ψ₁(G₀,G₁,A₁)

It is possible to extend this contamination scenario to a pedigree (and by implication a branching or series which are just special types of pedigrees). It is assumed that sample 0 is always the root of the pedigree and it is this sample that contaminates all the other samples. This fits a cancer scenario where there may be multiple copies of a tumor, some of which are descended from one another and all of which will be contaminated by normal tissue. There may also be other contamination situations (for example a sample being contaminated by two or more other samples) that can be formulated in a similar way.

The various factors need to be extended to include a reference to G₀ and to the various Aᵢ (each sample may be contaminated to a different degree) otherwise the computations are similar to the earlier pedigree without contamination.

ψ₀(G₀)≡P(s₀|G₀)P(G₀)

ψᵢ(G₀,Gᵢ,Aᵢ)≡P(sᵢ|Gᵢ,G₀,Aᵢ)P(Gᵢ|G₀)i^{↑}=0

ψᵢ(Gᵢ_{^{↑}},Gᵢ,G₀,Aᵢ)≡P(sᵢ|Gᵢ,G₀,Aᵢ)P(Gᵢ|Gᵢ_{^{↑}})i^{↑}≠0

P(χ)=ψ₀(G₀)Πᵢ_{^{↑}}₌₀ψᵢ(G₀,Gᵢ,Aᵢ)Πᵢ_{^{↑}}_{≠0}ψᵢ(Gᵢ_{^{↑}},Gᵢ,G₀,Aᵢ)

### 5. Parents

Above, the case where a sample has a single parent has been described. In this section the situation for a eukaryote resulting from sexual reproduction by two parents is developed.

Let i^{↑} be the (unique) father of node i and i^{†} be the (unique) mother of node i. i is a root if it has no father or mother. It is assumed that if one parent is present then the other is also. This can be achieved by adding a sample which contains no reads (S=θ).

Let i^{↓} to be all the children of i, that is, i^{↓}={j:i=j^{↑}vi=j^{†}}.

Let i [symbol] j be true (i and j are mated) if i and j have one or more children in common, that is,

i [symbol] j≡i^{↓}∩j^{↓}≠θ [symbol] i≠j

i is a leaf if it has no children, that is, i^{↓}=θ

The (full) siblings of i are given by

sib(i)=(i^{↑})^{↓}∩(i^{†})^{↓}−{i}

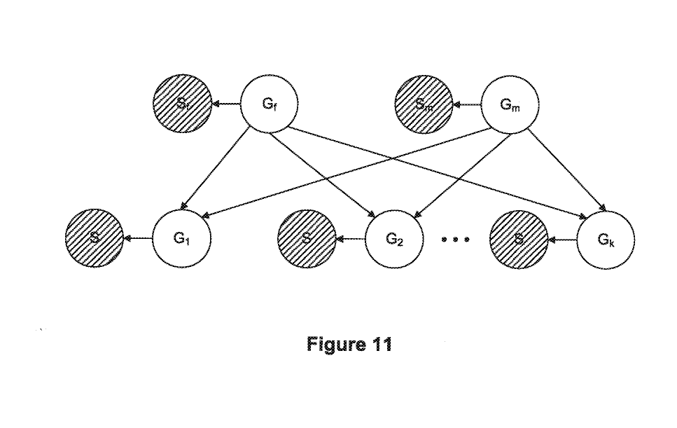

FIG. 10 shows a Bayesian Network for a simple family with two parents and one child.

P(Gⱼ|s) can be computed from:

P(χ)=P(sᵢ_{^{↑}}|Gᵢ_{^{↑}})P(sᵢ_{^{†}}|Gᵢ_{^{†}})P(sᵢ|Gᵢ)P(Gᵢ|Gᵢ_{^{↑}},Gᵢ_{^{†}})P(Gᵢ_{^{↑}})P(Gᵢ_{^{†}})

Refactoring in terms of ψ gives

ψᵢ_{^{↑}}(Gᵢ_{^{↑}})=P(sᵢ_{^{↑}}|Gᵢ_{^{↑}})P(Gᵢ_{^{↑}})

ψᵢ_{^{†}}(Gᵢ_{^{†}})=P(sᵢ_{^{†}}|Gᵢ_{^{†}})P(Gᵢ_{^{†}})

ψᵢ(Gᵢ,Gᵢ_{^{↑}},Gᵢ_{^{†}})=P(Gᵢ|Gᵢ_{^{↑}},Gᵢ_{^{†}})P(sᵢ|Gᵢ)

then

P(χ)=ψᵢ(Gᵢ,Gᵢ_{^{|}},Gᵢ_{^{†}})ψᵢ_{^{↑}}(Gᵢ_{^{↑}})ψᵢ_{^{†}}(Gᵢ_{^{†}})

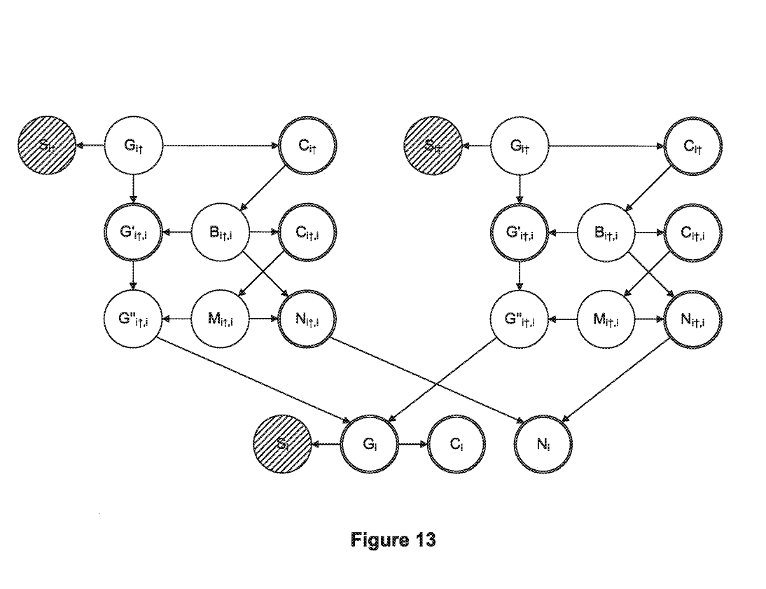

As in the single parent case P(Gᵢ|Gᵢ_{^{↑}},Gᵢ_{^{†}}) can be expanded to explicitly allow for copy number and genotype mutations. FIG. 13 illustrates a Bayesian network for this case.

The network used in the single parent case has been replicated twice, once for each parent. The calculations for each of the terms G′, G″, B, C, M, N can be performed in the same way as in the single parent case.

Two new deterministic calculations are included in this example. Gᵢ is deterministically computed from G″ᵢ_{^{↑}}_{,i} and G″ᵢ_{^{↑}}_{,i}. This is done by appending the two genotype vectors and sorting the result. Nᵢ is deterministically computed as the logical or of Nᵢ_{^{↑}}_{,i} and Nᵢ_{^{†}}_{,i}.

As shown in the single parent case the CPD P(Gᵢ|Gᵢ_{^{↑}},Gᵢ_{^{†}}) can be computed by summing over the B, M variables. If it is wished to infer any of the G′, G″, B, C, M, N then the expression P(χ) can be expanded to include them (the details of this have been omitted for conciseness).

This formulation can deal with the following cases amongst many others.

Sexually reproducing eukaryote autosomes have Cᵢ_{^{↑}}=Cᵢ_{^{†}}=Cᵢ=2 (including the pseudo-autosomal regions on human (eutherian) X and Y chromosomes). In this case the haplotypes are chosen randomly from each parent (ignoring mutations and other non-Mendelian mechanisms such as gene conversion or copy number changes). This is quantified by letting P( [symbol] 1,0 [symbol] |2)=P( [symbol] 0,1 [symbol] |2)=½ for P(Bᵢ_{^{↑}}_{,i}|Cᵢ_{^{↑}}_{,i}) and P(Bᵢ_{^{†}}_{,i}|Cᵢ_{^{†}}_{,i}).

For a human (eutherian) X chromosome when the child is female the copy numbers are Cᵢ_{^{↑}}=1, Cᵢ_{^{†}}=2, Cᵢ=2 then P(Bᵢ_{^{↑}}_{,i}= [symbol] 1 [symbol] |Cᵢ_{^{†}}_{,i}=1 and P(Bᵢ_{^{†}}_{,i}= [symbol] 1,0 [symbol] Cᵢ_{^{†}}_{,i}=2)=P(Bᵢ_{^{†}}_{,i}= [symbol] 0,1 [symbol] |Cᵢ_{^{†}}_{,i}=2)=½

### 6. Family

The Bayesian network in FIG. 11 illustrates the situation for two parents and multiple children.

P(G_{J}|s) can be computed from:

P(χ)=P(s_{f}|G_{f})P(G_{f})P(sₘ|Gₘ)P(Gₘ)Πᵢ₌ₗ^{k}P(sᵢ|Gᵢ)P(Gᵢ|Gᵢ_{^{↑}},Gᵢ_{^{†}})

(note that i^{↑}=f and i^{†}=m for all the children).

Refactoring in terms of ψ gives

ψ_{f}(G_{f})=P(s_{f}|G_{f})P(G_{f})

ψₘ(Gₘ)=P(sₘ|Gₘ)P(Gₘ)

ψᵢ(Gᵢ,Gᵢ_{^{↑}},Gᵢ_{^{†}})=P(Gᵢ|Gᵢ_{^{↑}},Gᵢ_{^{†}})P(sᵢ|Gᵢ)

then

P(χ)=ψ_{f}(G_{f})ψₘ(Gₘ)Πᵢ₌₁^{k}ψᵢ(Gᵢ,Gᵢ_{^{↑}},Gᵢ_{^{†}})

6.1. Extended Pedigree

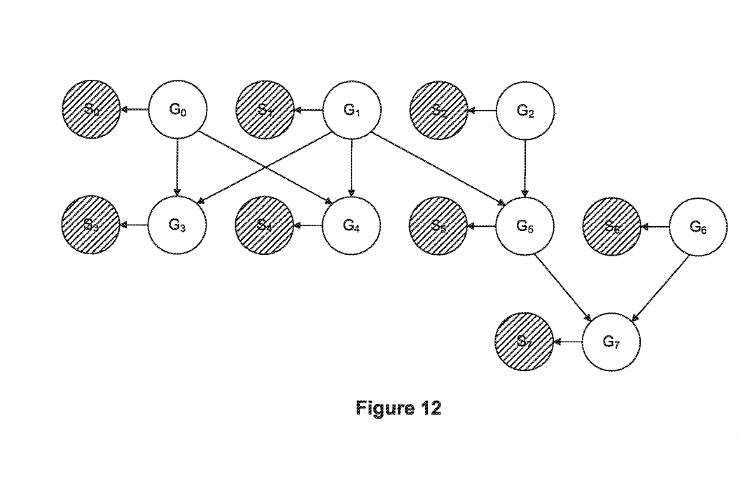

The example in FIG. 12 shows a Bayesian network for an extended pedigree with multiple generations.

As usual P(χ) will be defined in terms of ψᵢ where

ψᵢ(Gᵢ=P(sᵢ|Gᵢ)P(Gᵢ) i is root

ψᵢ(Gᵢ,Gᵢ_{^{↑}},Gᵢ_{^{†}})=P(Gᵢ|Gᵢ_{^{↑}},Gᵢ_{^{†}})P(sᵢ|Gᵢ) i not root

P(χ)=Π_{i is root}ψᵢ(Gᵢ)×Π_{i not root}ψᵢ(Gᵢ,Gᵢ_{^{↑}},Gᵢ_{^{†}})

Efficient calculation of the inferences in such an extended pedigree can be done with Belief Propagation if the pedigree is a polytree (there is at most one path between any two nodes in the network). When there is inbreeding and multiple paths, loopy Belief Propagation and convergence can be used.

### 7. Phenotypes

Consider a pedigree where the presence or absence of some phenotypic trait (D) is known for each sample. The values for D can be a disease, or any other trait caused by a single variant. It is desired to infer possible genetic explanations for this (U). Note that U has a single value across all samples (but will vary from locus to locus). This is useful because it can provide more accurate estimations of the reliability of a possible cause of a trait than working directly off called individual genotypes.

The range of U is all sets of genotypes that might explain the trait, including the empty set for when the locus is unable to explain the trait. For example, if a genotype is a diploid SNP with a dominant allele A then μ={ [symbol] A,A [symbol] , [symbol] A,C [symbol] , [symbol] A,G [symbol] , [symbol] A,T [symbol] }.

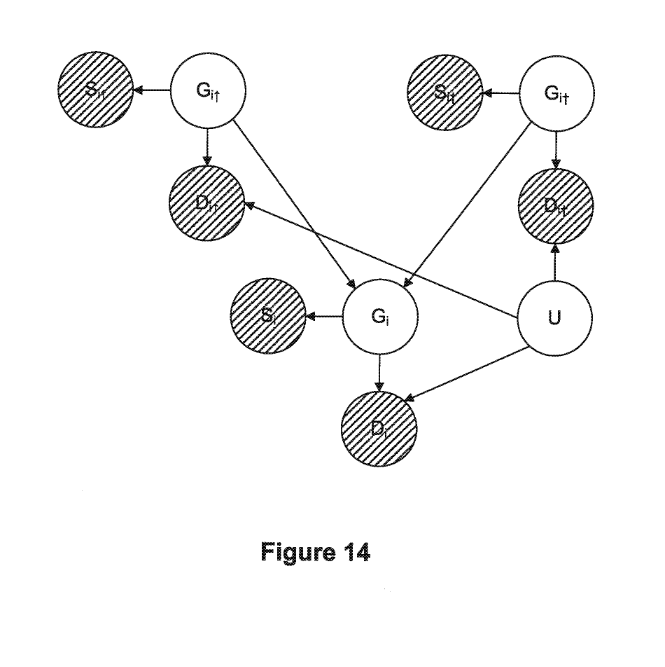

The Bayesian Network in FIG. 14 shows an example of a pedigree with two parents and one child including the traits (D) and the explanation U. The Dᵢ are shown shaded because they are usually known and they are also deterministically computed from Gᵢ and U.

Going directly to a full pedigree then P(χ) will be defined in terms of ψᵢ which now includes U as an argument. A prior P(U) is also included for the explanation.

ψᵢ(Gᵢ,U)=P(sᵢ|Gᵢ)P(Gᵢ)

whenever Dᵢ=GᵢεU and i is a root

ψᵢ(Gᵢ,Gᵢ_{^{†}},Gᵢ_{^{†}},U)=P(Gᵢ|Gᵢ_{^{↑}},Gᵢ_{^{†}})P(Sᵢ|Gᵢ)

whenever Dᵢ=GᵢεU and i is not a root

P(χ)=P(U)Π_{i is root}ψᵢ(Gᵢ)×Π_{i not root}ψᵢ(Gᵢ,Gᵢ_{^{↑}},Gᵢ_{^{†}})

The most important inferences include P(Gᵢ|s) and P(U|s,d).

The prior P(U) can encode a number of biological aspects. For example it may be known that the trait is recessive or dominant which can be encoded by altering which subsets in U have non-zero probabilities. Also the prior probabilities for alleles that are known to be of high prevalence in a population can be reduced for unusual traits such as rare diseases, for example by lowering the probabilities according to a down-weighting factor. The down-weighting factor could be determined, e.g., as a function of the ratio of the prevalence of the disease to the prevalence of the allele.

### 8. Combinations

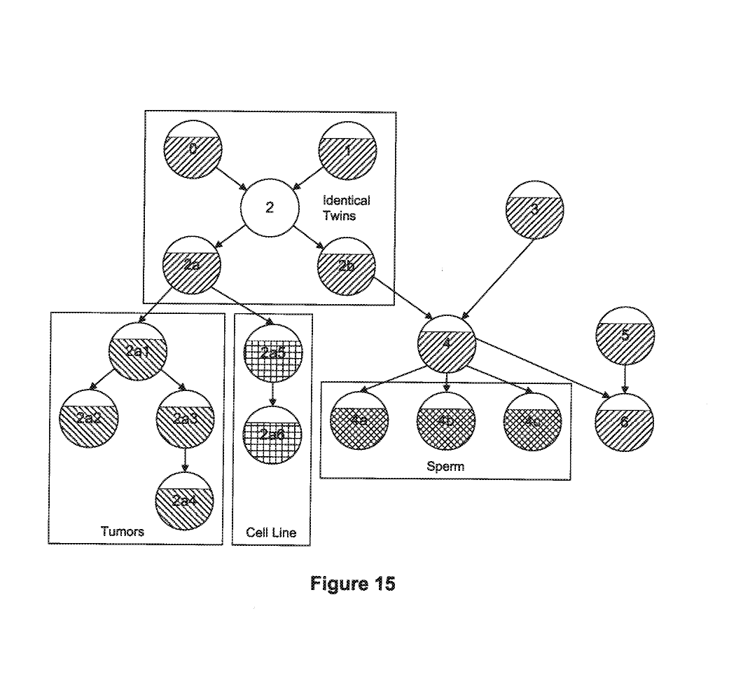

There are many biologically useful ways of combining these various different analyses. One example is given as a pedigree diagram in FIG. 15. This shows a family pedigree with various single descent lineages attached as well as a pair of identical twins in the middle.

Exemplary combinations include:
Cancer branching series descended from an individual within a family pedigree (see sample 2a1 and below).
Cell line branching series descended from an individual within a family pedigree (see sample 2a5 and below).
Multiple sperm samples branched from a single individual (see below 4).
Combinations of each of these branching series descended from the same individual (see 2a and below and 2b and below).
Identical twins in the middle of a pedigree (see sample 2 and samples 2a and 2b). Sample 2 is the hypothetical sequence of the conception before the two twins split. Thus 2a and 2b may contain de novo mutations not present in 2.

The general principle of how to combine these elements uses the expression P(χ) which encapsulates the full Bayesian Network. In each case this has been defined as the product of the various ψᵢ factors. The details of how each of these is defined and which random variables they take as arguments may vary from sample to sample. Nonetheless, they can still be combined into one product for the whole pedigree. So in generalized form,

P(χ)=Πᵢψᵢ(Gᵢ)

where Gᵢ is the genotype Gᵢ and its parents (if any).

This also works when the trait explanation U is included, yielding

P(χ)=P(U)Πᵢψᵢ(Gᵢ∪{U})

In certain embodiments, the entire genome of a biological sequence source is modelled. In certain embodiments, at least 80%, 90%, 95%, 99%, or 99.9% of the genome of a biological sequence source is modelled. In certain embodiments, at least 80%, 90%, 95%, 99%, 99.9%, or all protein-coding sequence in the genome of a biological sequence source is modelled. In certain embodiments, an entire chromosome, multiple chromosomes, or an amount of sequence equivalent to an entire chromosome or multiple chromosomes of a biological sequence source is modelled. In certain embodiments, a subset of a chromosome is modelled. In certain embodiments, the full length of the most likely or probable value for a modelled genomic sequence is provided. In certain embodiments, only a subset of the full length of the modelled genomic sequence is provided as a most likely or probable value. In certain embodiments, one value is provided for a modelled genomic sequence. In certain embodiments, two, three, five, or more than ten values are provided for a modelled genomic sequence. In certain embodiments, a complete genomic sequence or subset of a genomic sequence is modelled for one or more than one sources. Thus, a complete genomic sequence or subset of a genomic sequence may be modelled for one, two, three, four, five, or more family members, cell lines, tissue samples, specimens, etc.

In certain embodiments, some or all of the biological sequence read information from one or more of the sources used in methods according to this disclosure is estimated from extrinsic data. Data is extrinsic relative to a source to the extent that it includes any information other than sequence data from the source. Thus, examples of extrinsic data include reference sequence data from a database, sequence data from a different but genetically related source, and phenotypic (trait) data.

As would be well understood by those of skill in the art, the disclosed methods may be performed by one or more processors executing program instructions stored on one or more memories. Certain embodiments comprise systems for calling biological sequences, in which the system comprises one or more processors configured to execute one or more modules and a memory storing the one or more modules, wherein the modules comprise the exemplary hardware components disclosed above.

Other embodiments of the invention will be apparent to those skilled in the art from consideration of the specification and practice of the invention disclosed herein. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept. It is intended that the specification and examples be considered as exemplary only, with a true scope and spirit of the invention being indicated by the following claims.

What is claimed is:

1. A method of calling a target biological sequence of a biological sequence source based on a set of sequence reads, the method performed by one or more processors executing program instructions stored on one or more memories, the instructions causing the one or more processors to perform the method comprising:
obtaining biological sequence read information from a target biological sequence source and a second biological sequence source, wherein the target source and the second source are genetically related;
modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source; and
a biological sequence of the second biological sequence source; and
one or more random variables chosen from:
contamination of a set of sequence reads that correspond to a biological sequence source;
the copy number of a genomic sequence of a biological sequence source;
the presence of de novo mutation in a genomic sequence of a biological sequence source; and
a phenotypic trait;
and
providing one or more likely values for one or more random variables in the set of random variables.

2. The method of claim 1, wherein the step of providing one or more likely values for one or more random variable in the set of random variables comprises providing one or more likely values for the biological sequence of the target biological sequence source.

3. The method of claim 1, wherein the step of obtaining the biological sequence read information comprises sequencing one or more biological samples using a DNA sequencing machine.

4. The method of claim 1, wherein the step of obtaining the biological sequence read information comprises amplifying DNA in one or more biological samples.

5. The method of claim 1, wherein the sequence read information represents DNA, RNA, or protein sequences.

6. The method of claim 1, wherein the one or more likely values for the biological sequence of the target source represents the entirety of at least one chromosomal sequence or an amount of sequence equivalent to the entirety of at least one chromosomal sequence.

7. The method of claim 1, wherein the one or more likely values for the genomic sequence of the target source represents a subset of one chromosomal sequence.

8. The method of claim 1, wherein the method further comprises providing one or more scores indicating the confidence associated with the one or more likely values for one or more random variable in the set of random variables.

9. The method of claim 1, wherein the step of modeling the probabilities of occurrence of possible values of a set of random variables incorporates the possibility that a read is incorrectly mapped.

10. The method of claim 1, wherein the step of obtaining the biological sequence read information further comprises obtaining biological sequence read information from one or more additional biological sequence sources;
wherein the set of random variables further comprises one or more subsets of variables comprising: the set of sequence reads, biological sequence, copy number, and/or presence of de novo mutation; and
wherein each subset of variables is associated with the one or more additional biological sequence sources.

11. The method of claim 10, wherein at least some of the biological sequence read information from at least one biological sequence source is estimated from extrinsic data.

12. The method of claim 10, wherein the biological sequence sources comprise a pedigree of at least five family members.

13. The method of claim 10, wherein the second biological sequence source is an individual with a degree of relationship of one to four to the target biological sequence source.

14. The method of claim 10, wherein the biological sequence sources comprise parents, siblings, half-siblings, or children of the target biological sequence source.

15. The method of claim 1, wherein the set of random variables comprises contamination of a set of sequence reads that correspond to a biological sequence source.

16. The method of claim 1, wherein the set of random variables comprises the copy number of a genomic sequence of a biological sequence source.

17. The method of claim 1, wherein the set of random variables comprises the presence of de novo mutation in a genomic sequence of a biological sequence source.

18. The method of claim 1, wherein the set of random variables further comprises at least one variable representing at least one phenotypic trait and a variable representing a genetic explanation for the at least one phenotypic trait.

19. A method of calling a target biological sequence of a biological sequence source based on a set of sequence reads, the method performed by one or more processors executing program instructions stored on one or more memories, the instructions causing the one or more processors to perform the method comprising:
obtaining biological sequence read information from a target biological sequence source and a second biological sequence source, wherein the target source and the second source are genetically related, and wherein the target source and the second source are not two members of a family of individual organisms;
modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source;
a biological sequence of the second biological sequence source; and
a variable representing contamination of a set of sequence reads that correspond to a biological sequence source; and
providing one or more likely values for one or more random variables in the set of random variables.

20. The method of claim 19, wherein the target biological sequence source comprises cancerous or pre-cancerous cells or tissue of an individual, and the second biological source comprises noncancerous cells or tissue of the individual.

21. The method of claim 19, wherein the target biological sequence source and the second biological source were sampled at different time points.

22. The method of claim 19, wherein the target biological sequence source and the second biological source are two different cell lines.

23. A system for calling a target biological sequence of a biological sequence source based on a set of sequence reads, the system comprising:
one or more processors configured to execute one or more modules; and
a memory storing the one or more modules, the modules comprising:
code for obtaining biological sequence read information from a target biological sequence source and a second biological sequence source, wherein the target source and the second source are genetically related;
code for modeling the probabilities of occurrence of the possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source; and
a biological sequence of the second biological sequence source; and
one or more random variables chosen from:
contamination of a set of sequence reads that correspond to a biological sequence source;
the copy number of a biological sequence of a biological sequence source;
the presence of de novo mutation in a biological sequence of a biological sequence source; and
a phenotypic trait;
and
code for providing one or more likely values for the biological sequence of the target source and/or one or more likely values for the biological sequence of the second biological sequence source.

24. The system of claim 23, further comprising a nucleic acid sequencer configured to provide biological sequence read information to the one or more modules.

25. The system of claim 24, wherein the sequencer is locally interfaced with the one or more modules or connected to the one or more modules through a network.
